(19) United States
(12) Patent Application Publication
(10) Pub. No.: US 2017/0019711 A1
(43) Pub. Date: Jan. 19, 2017

(54) MULTIPLEXING TARGETED ADVERTISEMENTS

(71) Applicant: International Business Machines Corporation, Armonk, NY (US)

(72) Inventors: Andrew S. Feltham, Chandlers Ford (GB); Dominic P. Harries, Hursley (GB); Graham White, Alton (GB)

(21) Appl. No.: 14/797,954

(22) Filed: Jul. 13, 2015

(51) Int. Cl. H04N 21/458; H04N 21/845; H04N 21/475; H04N 21/81; H04N 21/433; H04N 21/45

(52) U.S. Cl. CPC H04N 21/458; H04N 21/4331; H04N 21/4532; H04N 21/4755; H04N 21/812; H04N 21/8456; H04N 21/4334

(57) ABSTRACT

Embodiments of the present invention provide systems and methods for displaying advertisements. These systems and methods employ a device capable of displaying advertisements, obtaining user profiles; assessing user profiles; broadcasting programs; caching advertisements; and displaying cached advertisement. Two channels are utilized where the first channel broadcasts program content and the second channel displays advertisement content. While programs are broadcasted, a set of advertisements associated with the assessed profile are cached. A time segment containing a set of advertisements is transposed from the second channel into the first channel during an advertisement break.

### BACKGROUND OF THE INVENTION

The present invention relates generally to transmitting broadcast content and more specifically to transmitting targeted advertising information during a broadcast.

Bi-directional communication (i.e., a user can receive a broadcast signal, as well as communicate back to the broadcaster) provides a means for the user to inform the broadcaster about the user's preferences. The users of media may submit profile information to the broadcaster in order to aid the broadcaster when choosing advertisements specifically targeted to the user of media. The profile information may include age, location, gender, sports preferences, and life style preferences.

Traditional terrestrial broadcasts communicate in one direction (i.e., the user receives a signal, but cannot communicate back to the broadcaster). Advertising using traditional terrestrial broadcasts may be broadly targeted to a large group of people based on a specific factor or a specific set of factors. Often, such a factor is a broad location, such as an advertisement campaign geared towards residents in metropolitan New York City.

### SUMMARY

According to one embodiment of the present invention, a method for displaying advertisements is provided, the method comprising the steps of: receiving, by a media receiver, information associated with a user profile; receiving, by the media receiver, a broadcast transmission comprising a first channel and a second channel, wherein the second channel comprises a plurality of advertisements divided into sets of advertisements of a known time segment; determining, by the media receiver, a set of advertisements from the plurality of advertisements, based on the user profile; detecting, by the media receiver, an advertisement break in the broadcast transmission; and responsive to detecting an advertisement break in the broadcast transmission, displaying, by the media receiver, the determined set of advertisements in the broadcast transmission.

Another embodiment of the present invention provides a computer system for displaying advertisements, based on the method described above.

Another embodiment of the present inventions provides a computer program product for displaying advertisements, based on the method described above.

### BRIEF DESCRIPTION OF THE DRAWINGS

FIG. 1 is a functional block diagram illustrating a broadcasting environment in accordance with an embodiment of the present invention;

FIG. 2 is a flowchart depicting operational steps for displaying targeted advertisements at predetermined time segments during a broadcast program, in accordance with an embodiment of the present invention;

FIG. 3 is an example timing scheme of displaying targeted advertisements at predetermined time segments throughout a broadcast program, in accordance with an embodiment of the present invention; and

FIG. 4 depicts a block diagram of internal and external components of a computing device, in accordance with an embodiment of the present invention.

### DETAILED DESCRIPTION

Bi-directional communication (i.e., a user can receive a broadcast signal, as well as communicate back to the broadcaster) allows a broadcaster to transmit advertising information to an end user. Embodiments of the present invention disclose systems and methods to allow the user to select from one of a set of targeted advertisements locally on a device used by the user (i.e., a receiver device). By setting up a user profile for the user, the user can select targeted advertisements. The selection of targets do not reach the broadcaster. Instead, a set of advertisements are stored on a receiver device using known time slots which permits the setting of different advertisements targeting different groups of users to be multiplexed into a channel different from the channel which is being watched by the users. At a time for displaying an advertisement, only one of the set of advertisements based upon criteria selected on the user device is seen by the user.

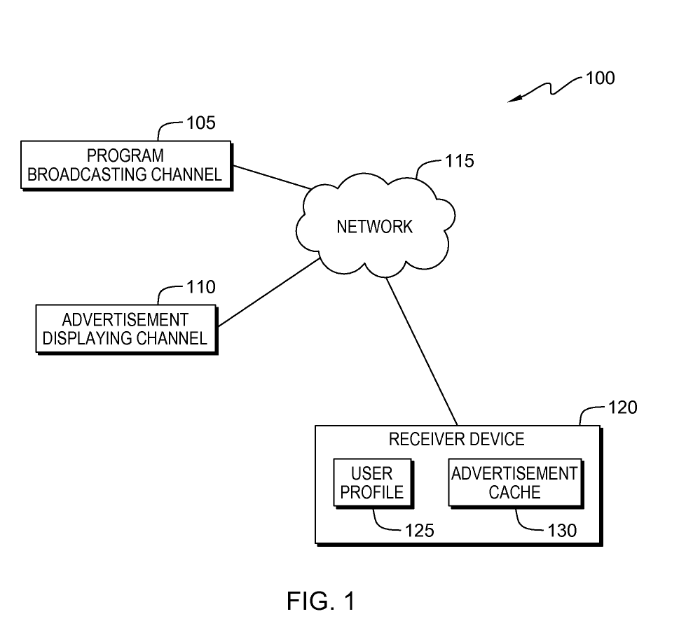

The present invention will now be described in detail with reference to the Figures. FIG. 1 is a functional block diagram illustrating a data broadcasting environment, generally designated 100, in accordance with one embodiment of the present invention. FIG. 1 provides only an illustration of implementation and does not imply any limitations with regard to the environments in which different embodiments may be implemented. Modifications to data broadcasting environment 100 may be made by those skilled in the art without departing from the scope of the invention as recited by the claims. In this exemplary embodiment, data broadcasting environment 100 includes program broadcasting channel 105, advertisement displaying channel 110, and receiver device 120, communicating over network 115.

Network 115 serves as a medium by which broadcasts are transmitted. Network 115 facilitates terrestrial broadcasts transmitted via television frequencies and radio frequencies. In general, network 115 can be any combination of connections and protocols that will support communication between receiver device 120, program broadcasting channel 105, and advertisement displaying channel 110.

Program broadcasting channel 105 transmits a data stream containing a program to receiver device 120 via network 115. A program is a certain segment of time during which content is broadcast. The data stream may include a standard broadcast stream; digital high definition broadcast; digital or analog radio; satellite TV or radio; or cable. The audio and video content may be transmitted in real time. Data sources, which produce broadcasting content, may work in combination with each other or separately, in order to transmit the audio and video content.

Advertisement displaying channel 110 transmits a data stream containing an advertisement to receiver device 120 via network 115. The data stream may include targeted advertising in which the targeted content may be standard broadcast commercial content or be commercial advertising content targeted to specific segments of the population, consisting of a standard broadcast stream; digital high definition broadcast; digital or analog radio; satellite TV or radio; or cable. The data stream from advertisement displaying channel 110 may contain audio and video content, as well as, data sources in combination with, or separate from, the audio and/or video content. The broadcasters of program broadcasting channel 105 and advertisement displaying channel 110 may be the same, or different from each other. Additionally, advertisement displaying channel 110 may comprise content from a plurality of different broadcasters and advertisers.

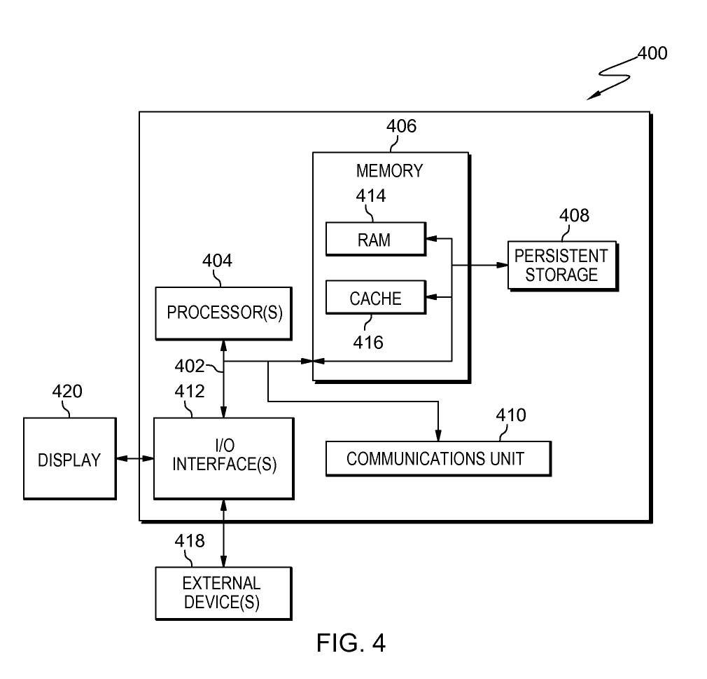

Receiver device 120 includes user profile 125 and advertisement cache 130. Receiver device 120 may be a digital television, a laptop computer, a tablet computer, a netbook computer, a personal computer (PC), a desktop computer, a personal digital assistant (PDA), a smart phone, a thin client, or any programmable electronic device capable of communicating with program broadcasting channel 105 and advertisement displaying channel 110 via network 115. Receiver device 120 includes a tuner (not depicted) configured to receive, decode, and present in high definition using: digital or analog radio; satellite TV; and radio broadcasts from channels such as program broadcasting channel 105 and advertisement displaying channel 110. Receiver device 120 may include display modules, audio modules, and human-machine interfaces such as haptic/touch screen interfaces. Receiver device 120 may include internal and external hardware components, as depicted and described in further detail with respect to FIG. 4.

User profile 125 is locally stored on receiver device 120, and contains information pertaining to a user. This information can consist of gender, age, country of residency, etc. The user may input and update the information on receiver device 120.

Advertisement cache 130 is a component that stores advertisement data so future requests to transmit the advertisement data can be served faster. The advertisement data stored in advertisement cache 130 may be the result of an earlier computation, or the duplicate of advertisement data stored elsewhere. Advertisement cache 130 facilitates the recording of advertisements to be accessed and potentially be reconfigured at a later time.

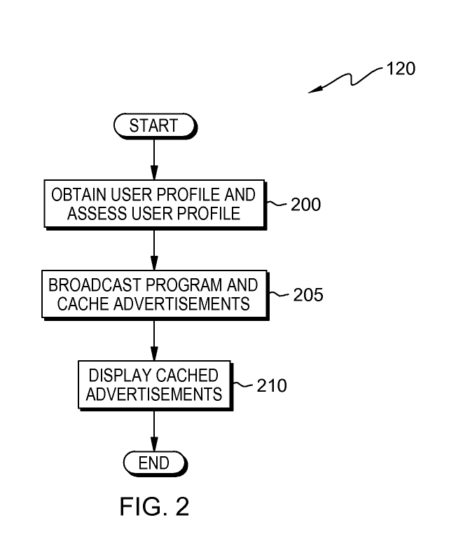

FIG. 2 is a flowchart depicting operational steps for displaying targeted advertisements at predetermined time segments during a broadcast program, in accordance with an embodiment of the present invention.

In step 200, receiver device 120 obtains a user profile and assesses the user profile. In this exemplary embodiment, a new channel (i.e., advertisement displaying channel 110), which is not directly consumable (although it can be), contains only advertisements. These advertisements are of a set length while being associated with a particular profile for a type of user. Receiver device 120 performs a profile capture where receiver device 120 may receive information pertaining to interests, age group, country of residence, and other demographic data of a user utilizing receiver device 120. The profile capture may also consist of a set of tick-boxes and questionnaires linked with on-line profiles, or some other method in order to capture a user profile. User profiles can be stored locally on a device or remotely on a server. Multiple numbers of profiles may exist which contain advertisements associated with the profile. The number of profiles are variable. Receiver device 120 (which could be a radio or TV) records or caches the advertisement displaying channel 110 for a set known period of time in order to “catch” a known number of advertisements associated with a profile. In this exemplary embodiment, the time comes for an advertisement break while employing receiver device 120 in order to watch a broadcast. Receiver device 120 looks up the profile type of the user, determines which time slice of the cached advertisements are to be displayed to each user based upon settings the user has made, and will eventually play only these advertisements associated with this profile back to the user during a commercial break. The same advertisements are broadcast to all users within a broadcast region. For example, four sets of advertisements are sent to South East England (i.e., the broadcast region). South East England is the targeted area, but each viewer may receive any one of the four sets of advertisements. On one receiving device in the region of South East England, a set of advertisements displayed is based upon age (e.g., marketing campaigns geared towards people over 50 years of age). On a second receiving device in the region of South East England, a set of advertisements displayed is based upon sports preferences (e.g., marketing campaigns geared towards soccer fans).

In step 205, receiver device 120 broadcasts a program and caches advertisements. In this exemplary embodiment, the broadcast program may vary in length and is transmitted through advertisement displaying channel 110. When receiver device 120 caches advertisements, receiver device 120 records a set of targeted advertisements and sends them to advertisement cache 130 (a component of data storage to be accessed at a later time). During the course of the program, there are commercial breaks. For example, the user watches a 60 minute program on program broadcasting channel 105 that has a 4 minute advertisement break every 15 minutes. Receiver device 120 displays the program from minute 1 to minute 60 and records the advertisements in advertisement displaying channel 110 to advertisement cache 130. Starting at minute 1, the program is broadcast until minute 15. After the advertisements are displayed at minute 15, the program resumes broadcasting. For example, profile B has been assessed to be the most appropriate advertisement profile on receiver device 120. Profiles A, C, and D are disregarded and not recorded to a cache. While watching the 60-minute program, advertisements associated with profile B within advertisement displaying channel 110 are recorded to advertisement cache 130.

In step 210, receiver device 120 displays cached advertisements. In this exemplary embodiment, a program stops for a commercial break (at a predetermined time interval) and receiver device 120 accesses advertisement cache 130 to determine which profile has been assessed to be the most appropriate match for an individual user. Then, receiver device 120 displays the cached advertisements associated with the advertisement profile assessed to be the most appropriate match for a profile of an individual user, discards other advertisements associated with the other profiles, and resumes caching advertisements. For example, the pattern repeats with advertisements being shown at minute 28 and minute 43 for a period of 4 minutes. Each time, the cached advertisements assessed to be the most appropriate match for the profile of the individual user are displayed, while discarding other cached advertisements associated with the other profiles. The group of advertisements are cached on receiver device 120 which can be accessed during an advertisement break. Receiver device 120 displays a group of advertisements to the user which are matched to the user profile. In this exemplary embodiment, the same group of advertisements are displayed to all users of receiver device 120 within a broadcast region. Additionally, receiver device 120 can immediately display a different set of advertisements if the profile is changed while a program is broadcasting as long as receiver device 120 cached all sets of advertisements.

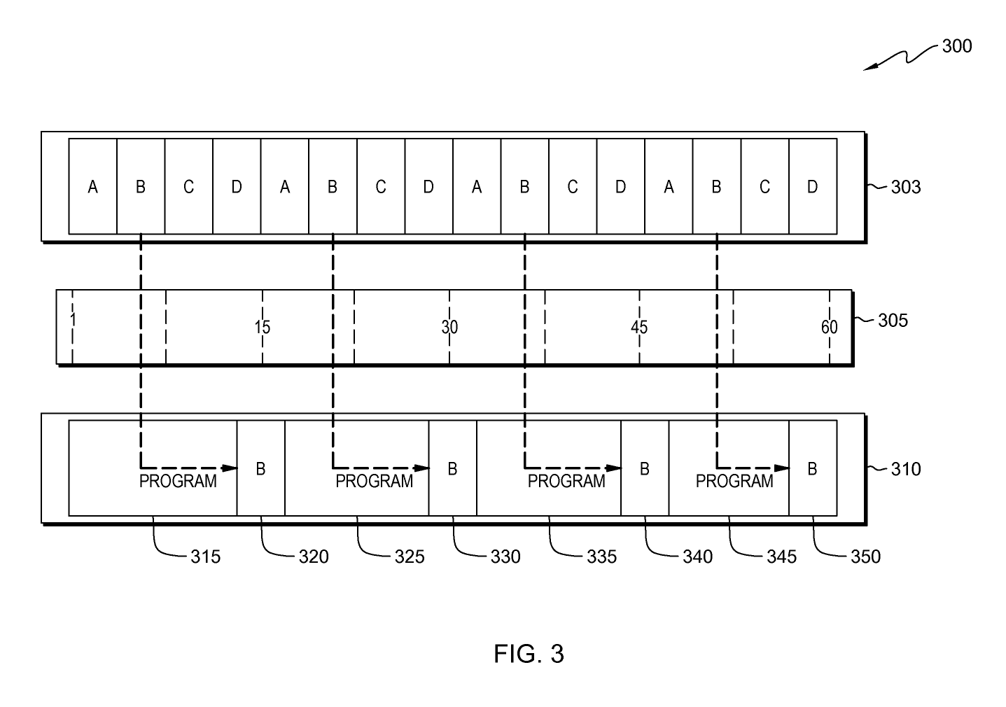

FIG. 3 is an example timing scheme 300 of displaying targeted advertisements at predetermined time segments throughout a broadcast program, in accordance with an embodiment of the present invention.

In this exemplary embodiment, advertisement channel 303 and program channel 310 represent the advertisement displaying channel 110 and program broadcasting channel 105, respectively. Row 305 depicts elapsed time using minutes as the unit of measure. For example, the diagram describes the timeline of a broadcast program and advertisements. Receiver device 120 shows the program channel 310 and records the advertisement channel 303. When the time comes for a commercial break, the recorded advertisement channel corresponding to the profile assessed to be the best match to the user is played back from the cache. A user profile is built up which takes into account information including demographic information and viewing habits of the user, and is stored on receiver device 120. The device then continues to record the advertisements channel and splice advertisements into the program channel when required. At minute 1, the program is displayed in block 315. At minute 13, only advertisements associated with profile B are displayed in block 320; advertisements associated with profiles A, C, and D are further disregarded; and advertisements associated with profile B are cached on program channel 310. After displaying advertisements only associated with profile B in block 320, the program resumes and is displayed in block 325. Advertisements associated with profile B are displayed again, after displaying block 325 at minute 28, in block 330. The program resumes and displays in blocks 335 and 345 with commercial breaks at minute 43 and 58 displaying advertisements associated with profile B in blocks 340, and 350, respectively. In this particular example, with a 4 minute advertisement break every 15 minutes, the device would need a 16 minute cache in order to record the advertisement channel. However, the number of advertisement channels, number of profiles, and length of advertisement breaks may vary depending on the system (e.g., DAB Radio, FM Radio, FreeSat, Sky, etc.) and thus the layout of the timeline changes in order to conform to the requirements of each system.

FIG. 4 depicts a block diagram of internal and external components of a computing device 400, which is representative of the computing devices of FIG. 1, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices via a network (e.g., network 115). In these examples, communications unit 410 includes one or more network interface cards. Communications unit 410 may provide communications through the use of either or both physical and wireless communications links. Software and data used to practice embodiments of the present invention can be downloaded to computing device 400 through communications unit 410 (e.g., via the Internet, a local area network or other wide area network). From communications unit 410, the software and data can be loaded onto persistent storage 408.

I/O interface(s) 412 allows for input and output of data with other devices that may be connected to computing device 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for displaying advertisements, the method comprising the steps of:
receiving, by a media receiver, information associated with a user profile;
receiving, by the media receiver, a broadcast transmission comprising a first channel and a second channel, wherein the second channel comprises a plurality of advertisements divided into sets of advertisements of a known time segment;
determining, by the media receiver, a set of advertisements from the plurality of advertisements, based on the user profile;
detecting, by the media receiver, an advertisement break in the broadcast transmission; and
responsive to detecting an advertisement break in the broadcast transmission, displaying, by the media receiver, the determined set of advertisements in the broadcast transmission.

2. The method of claim 1, wherein determining, by the media receiver, the set of advertisements from the plurality of advertisements, based on the user profile comprises:
comparing, by one or more processors, the plurality of advertisements to a first user profile;
determining, by one or more processors, attributes associated with the first user profile are similar to attributes associated with at least one set of advertisements from the plurality of advertisements; and
displaying, by one or more processors, the at least one set of advertisements having similar attributes to the attributes associated with the first user profile.

3. The method of claim 1, wherein the first channel broadcasts media content and the second channel simultaneously caches the plurality of advertisements.

4. The method of claim 1, further comprising:
storing, by the media receiver, the plurality of advertisements from the received broadcast transmission in a cache; and
retrieving, by the media receiver, from the cache, the determined set of advertisements from the plurality of advertisements.

5. The method of claim 1, wherein displaying, by the media receiver, the determined set of advertisements in the broadcast transmission comprises:
transposing, by the media receiver, a time segment containing a set of advertisements from the second channel into the first channel, responsive to detecting the advertisement break in the broadcast transmission.

6. The method of claim 1, wherein displaying, by the media receiver, the determined set of advertisements in the broadcast transmission, further comprises:
recording, by the media receiver, a plurality of advertisements from the second channel of the broadcast transmission.

7. The method in claim 1, wherein determining, by the media receiver, a set of advertisements from the plurality of advertisements, based on the user profile comprises:
at a first location, determining, by the media receiver, a first set of advertisements from the plurality of advertisements, based on a first user profile; and
at the first location, determining, by the media receiver, a second set of advertisements from the plurality of advertisements, based on a second user profile.

8. A computer system for displaying advertisements, the computer system comprising:
one or more computer processors;
one or more computer readable storage media;
program instructions stored on the one or more computer readable storage media for execution by at least one of the one or more processors, the program instructions comprising:
program instructions to receive information associated with a user profile;
program instructions to receive a broadcast transmission comprising a first channel and second channel, wherein the second channel comprises a plurality of advertisements divided into sets of advertisements of a known time segment;
program instructions to determine a set of advertisements from the plurality of advertisements, based on the user profile;
program instructions to detect an advertisement break in the broadcast transmission; and
program instructions to, responsive to detecting an advertisement break in the broadcast transmission, display the determined set of advertisements in the broadcast transmission.

9. The computer system of claim 8, wherein program instructions to determine the set of advertisements from the plurality of advertisements, based on the user profile comprise:
program instructions to compare the plurality of advertisements to a first user profile;
program instructions to determine attributes associated with the first user profile are similar to attributes associated with at least one set of advertisements from the plurality of advertisements; and
program instructions to display the at least one set of advertisements having similar attributes to the attributes associated with the first user profile.

10. The computer system of claim 8, wherein the first channel broadcasts media content and the second channel simultaneously caches the plurality of advertisements.

11. The computer system of claim 8, further comprising:
program instructions to store the plurality of advertisements from the received broadcast transmission in a cache; and
program instructions to retrieve, from the cache, the determined set of advertisements from the plurality of advertisements.

12. The computer system of claim 8, wherein program instructions to display the determined set of advertisements in the broadcast transmission comprise:
program instructions to transpose a time segment containing a set of advertisements from the second channel into the first channel, responsive to detecting the advertisement break in the broadcast transmission.

13. The computer system of claim 8, wherein program instructions to display the determined set of advertisements in the broadcast transmission, further comprise:
program instructions to record a plurality of advertisements from the second channel of the broadcast transmission.

14. The computer system of claim 8, wherein program instructions to determine a set of advertisements from the plurality of advertisements, based on the user profile comprise:
program instructions to, at a first location, determine a first set of advertisements from the plurality of advertisements, based on a first user profile; and
program instructions to, at the first location, determine a second set of advertisements from the plurality of advertisements, based on a second user profile.

15. A computer program product for displaying advertisements, the computer program product comprising:
a computer readable storage medium and program instructions stored on the computer readable storage medium, the program instructions comprising:
program instructions to receive information associated with a user profile;
program instructions to receive a broadcast transmission comprising a first channel and second channel, wherein the second channel comprises a plurality of advertisements divided into sets of advertisements of a known time segment;
program instructions to determine a set of advertisements from the plurality of advertisements, based on the user profile;
program instructions to detect an advertisement break in the broadcast transmission; and
program instructions to, responsive to detecting an advertisement break in the broadcast transmission, display the determined set of advertisements in the broadcast transmission.

16. The computer program product of claim 15, wherein program instructions to determine the set of advertisements from the plurality of advertisements, based on the user profile comprise:
program instructions to compare the plurality of advertisements to a first user profile;
program instructions to determine attributes associated with the first user profile are similar to attributes associated with at least one set of advertisements from the plurality of advertisements; and
program instructions to display the at least one set of advertisements having similar attributes to the attributes associated with the first user profile.

17. The computer program product of claim 15, wherein the first channel broadcasts media content and the second channel simultaneously caches the plurality of advertisements.

18. The computer program product of claim 15, further comprising:
program instructions to store the plurality of advertisements from the received broadcast transmission in a cache; and
program instructions to retrieve, from the cache, the determined set of advertisements from the plurality of advertisements.

19. The computer program product of claim 15, wherein program instructions to display the determined set of advertisements in the broadcast transmission comprise:
program instructions to transpose a time segment containing a set of advertisements from the second channel into the first channel, responsive to detecting the advertisement break in the broadcast transmission.

20. The computer program product of claim 15, wherein program instructions to display the determined set of advertisements in the broadcast transmission, further comprise:
program instructions to record a plurality of advertisements from the second channel of the broadcast transmission.
